(19) United States
(12) Patent Application Publication
(10) Pub. No.: US 2008/0314205 A1
(43) Pub. Date: Dec. 25, 2008

(54) Quick release pliers for push-fit couplers

(76) Inventor: Carlos Feliciano, Orlando, FL (US)

Correspondence Address: ELSIE C. TURNER, 201 PARK PLACE, SUITE 204, ALTAMONTE SPRINGS, FL, 32701, US

(21) Appl. No.: 11/975,563

(22) Filed: Oct. 22, 2007

Related U.S. Application Data
(60) Provisional application No. 60/936,780, filed on Jun. 23, 2007.

(51) Int. Cl. B25B 7/02

(52) U.S. Cl. 81/426

(57) ABSTRACT

A pair of pliers for connecting or disconnecting a push-fit coupler with an internal toothed grab ring has forked, U-shaped opposing jaws, one of which is sized to fit to hold a cylindrical pipe connected to a push-fit coupler, and the other jaw sized to hold the exterior support sleeve of the coupler, so that squeezing the pliers will compress the internal grab ring, causing the teeth to splay thus freeing the pipe so that it may be removed from the coupler. The pliers may also be used to splay the teeth while inserting a pipe into the coupler.

### RELATED U.S. APPLICATIONS

U.S. Provisional Application Ser. No. 60/936,780, filed Jun. 23, 2007, of which the Applicant claims the benefit.

### FIELD OF THE INVENTION

This invention relates the field of pipe couplings connections, and more particularly to a tool for connecting and disconnecting a push-fit pipe connector.

### BACKGROUND OF THE INVENTION

Various traditional means of connecting pipe include soldering the joints of metal unthreaded pipe, and the use of threaded connectors with plumber's tape plastic applied to the threads to produce a leakproof connection. Typically known means for connecting pipes involve machining and numerous parts which may be difficult to assemble on site. Connecting and disconnecting sections of pipe in a tight space can present problems when the use of a pipewrench or gas torch is required. Other difficulties pertain when high pressures are involved. Recent developments in pipe coupling to simplify connections and make them secure include a plubing connection and disconnection system and method, U.S. Pat. No. 6,578,876 to Guertin, comprising a threaded adapter and coupler assembly with one end right-hand-threaded, and the opposite end left-hand-threaded, for simultaneous tightening at both ends. It requires use of a wrench-type tool. Another development is a self-contained anchoring and gripping device for a pipe coupling containing an annular gripping ring inside a clamping device, disclosed in a patent application, Pub. No. US2005/0104369 filed by Webb et al. and published May 19, 2005. Yet another system for securing two pipes is presented in Davidson's application for patent, U.S. 2005/0006897, published Jan. 13, 2005. U.S. Pat. No. 6,904,835 to Dugan discloses a coupler that grips the internal surface of a torque receptor such as a threaded pipe. When torque is applied to the coupler, a cam mechanism forces apart the gripping surfaces. A torque wrench is required to screw or unscrew the coupling.

Recently, Cash Acme®, a division of the Reliance Worldwide Corporation, has developed a push-fit coupling, named the SharkBite® System, that works in two stages. When a pipe end is inserted into the fitting, it passes through a first stage through a release collar and then through a stainless steel grab ring with teeth that splay out and grip the tube. At the second stage the tube is pushed through an aligning o-ring, then through another o-ring, which is compressed between the wall of the fitting and the tube end, until the tube end reaches a tube stop. This system is more particularly described below. A disassembly clip or tongs are available for disassembling the fitting from a pipe by squeezing the release collar to splay the grab ring teeth. Use of the clip involves having one hand enveloping the fitting which may not be possible where space is limited. The tongs allow remote access but require much hand strength because they must be stiff enough to overcome the resistance of the grab ring without bending and dissipating the force applied to them. There is no mechanical advantage to the tongs, only remote access. Thus the object of this invention is to provide a more desirable tool for compressing the release collar that will provide remote access to the fitting in a tight space and also a mechanical advantage utilizing leverage to provide strength.

### SUMMARY OF THE INVENTION

A pliers is provided for connecting or disconnecting a push-fit pipe coupler with an internal toothed grab ring to releasably engage a pipe end. The pliers have forked, U-shaped opposing jaws, the shape and size of one said jaw selected to fit snugly around the cylindrical pipe to be joined by the coupler, and the other jaw sized to fit snugly around the exterior support sleeve of the coupler, so that squeezing the pliers will compress the internal grab ring causing the teeth to splay, so that the pipe may be either removed from the coupler, or easily inserted into it.

### BRIEF DESCRIPTION OF THE DRAWINGS

FIG. 1 is a perspective view of the push-fit coupler pliers of this invention together with a perspective view of a push-fit coupler connected to tubing

FIG. 2 is a longitudinal sectional view of an installed push-fit coupler together with the pliers of this invention about to disconnect the push-fit coupler from the tubing;

FIG. 3 is similar to FIG. 2 but illustrates the action of the pliers squeezing the push-fit coupler to splay teeth within the coupler open to disengage from the tubing;

FIG. 4 is a longitudinal sectional view of the push-fit pliers about to force open the teeth so that a tube may be inserted into the push-fit tube coupler;

FIG. 5 illustrates the action of the pliers splaying open the teeth as tubing is inserted into the push-fit coupler.

### DETAILED DESCRIPTION OF THE DRAWINGS

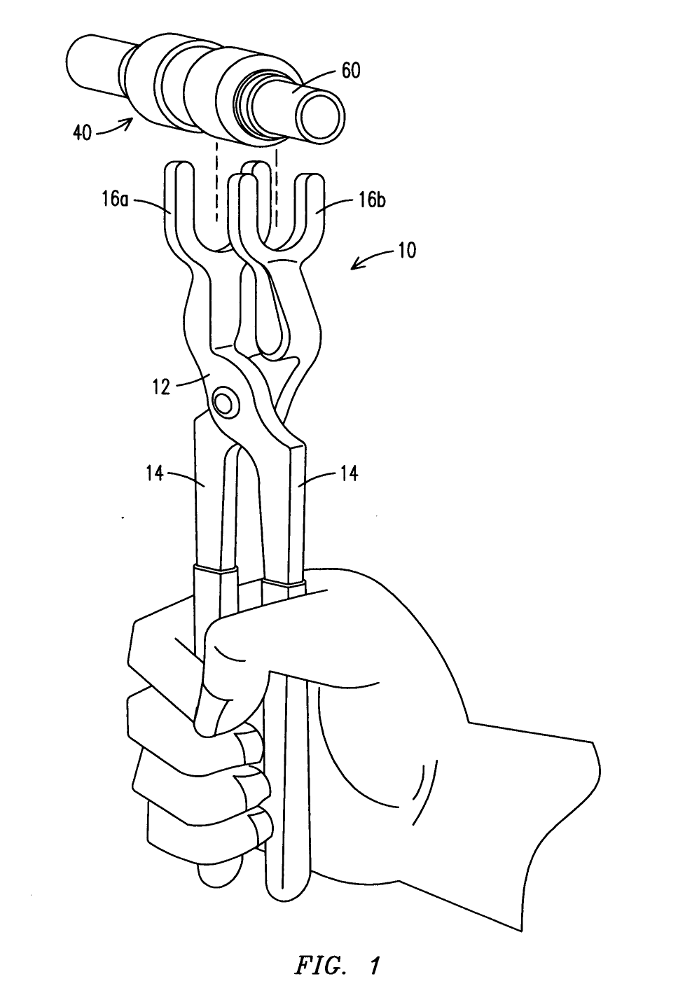

Referring to FIGS. 1-5, there is shown a pliers 10 for ease of connecting and disconnecting tubing 60 from a double-ended push-fit coupler 40 such as a SharkBite® fitting manufactured by Cash Acme, a division of Reliance Worldwide Corporation. The ensuing description is of one end of the coupler 40, it being understood that the other end is a mirror image of the end described herein.

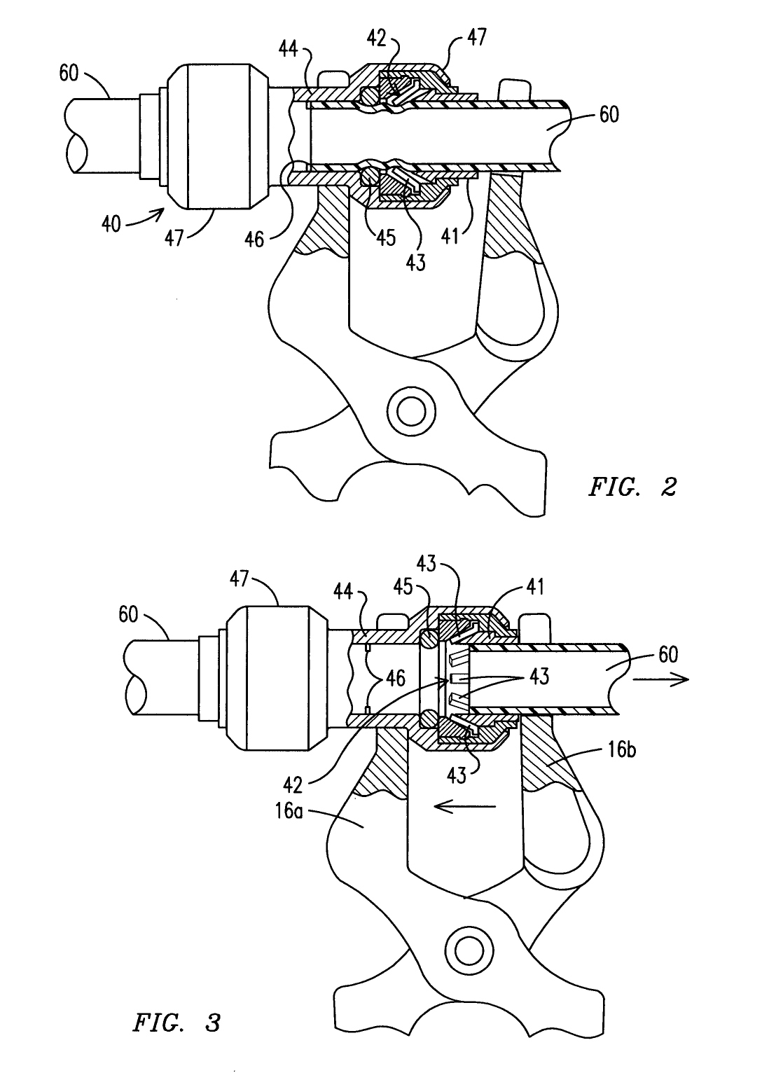

Referring to FIG. 2, each end of coupler 40 has a cylindrical release collar 41, an abutting grab ring 42 for engaging tubing 60, and a tubular wall section 44 joining the two ends of coupler 40. Wall section 44 is integral with a support sleeve 47 at each end which encloses the operative parts of the coupler, to be described below. Wall section 44 contains an internal stop 46 limiting the extent of intrusion of tubing 60 into coupler 40. Support sleeve 47 partially envelops release collar 41 which can move inward under external compression to bias a grab ring 42 having teeth 43 disposed frusto-conically within support sleeve 47. The teeth 43 releasably grip tubing 60 inserted through release collar 41 into wall section 44. The internal diameter of wall section 44 is sized to fit over tubing 60.

When tubing 60 is inserted into the coupler 40 it passes through release collar 41, then through grab ring 42 where teeth 43 engage tubing 60. A sealing O-ring 45 is compressed between wall section 44 and tubing 60 as the end of the tubing reaches the internal stop 46.

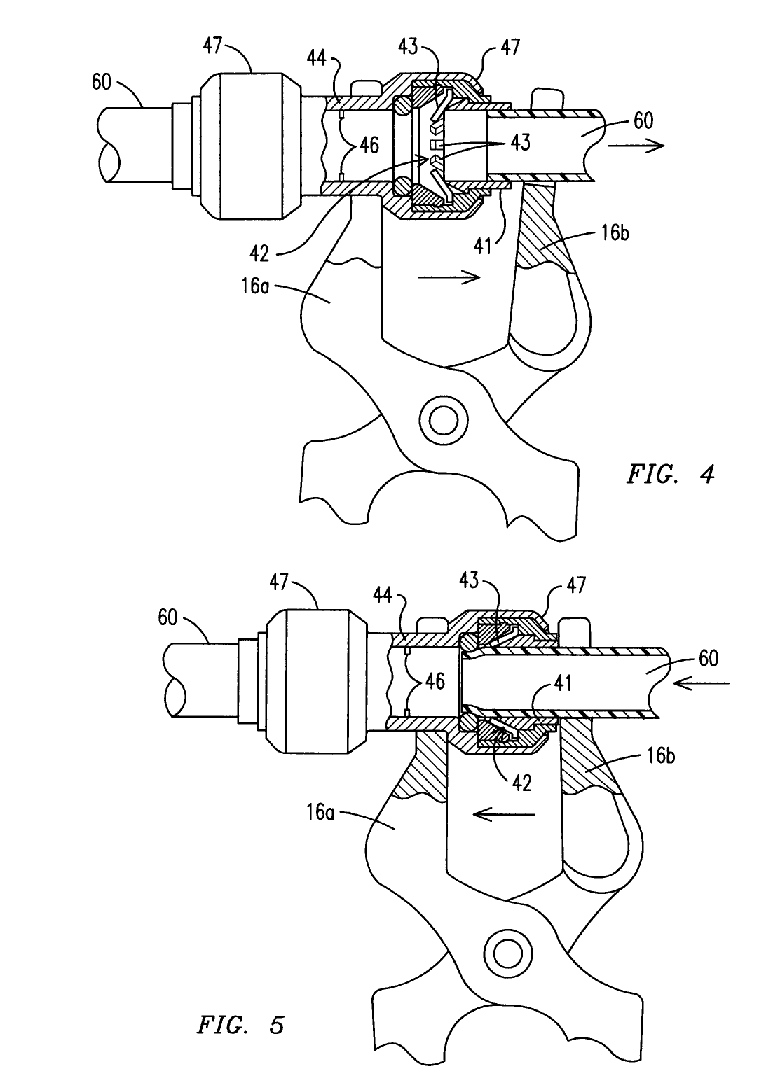

Pliers 10 comprises a pair of lever arms 12 pivotally joined at a pivot 13, each lever arm 12 comprising a handle end 14 and a jaw end 16a or 16b. Jaw ends 16a and 16b are forked, generally U-shaped, the radius of the curve at the nadir of 16a being sized to fit snugly around wall section 44 and against support sleeve 47 of the coupler 40, whereas the radius of the curve of 16b is sized to fit snugly around tubing 60 and against release collar 41. As seen in FIG. 3, when pliers 10 is in position, with wall section 44 seated in jaw 16a and tubing 60 seated in jaw 16b so that release collar 41 abuts jaw 16b, squeezing the handle ends 44 moves release collar 41 inward to bias grab ring 42, and teeth 43 are splayed radially outward, thereby freeing tubing 60 for removal as in FIG. 3. FIG. 4 shows tubing 60 partially withdrawn from the coupler and release collar 41 in its uncompressed position.

In FIG. 5, pliers 10 are shown biasing release collar 41 inward in position for insertion of tubing 60 into the push-fit coupler 40. Tubing 60 is only partially inserted in this view.

Since the SharkBite® coupler comes in varying sizes, depending on the diameter of the tubing to be used in a particular installation, the pliers of this invention can be made to fit each size of coupler.

It is to be understood that modifications and changes of the described embodiment may be made by a person normally skilled into art of pipe coupling without departing from the scope of the invention.

I claim:

1. A pliers for connecting or disconnecting a push-fit pipe coupler to or from a section of cylindrical pipe, said coupler having at least one end comprising a cylindrical release collar abutting a grab ring having resilient releasably-gripping teeth for engaging cylindrical pipe, and a tubular wall section integral with a support sleeve partially enclosing the release collar, said pliers comprising:
1. A pair of opposing forked jaw members, one of said jaw members being sized to fit snugly around the tubular wall section and against the support sleeve of a push-fit pipe coupler; and the other jaw member being sized to accommodate a cylindrical pipe to be engaged by the push-fit coupler while abutting the release collar of said coupler, whereby placing the pliers so as to grasp said support sleeve and squeezing the pliers to bias the jaw members toward each other causes the teeth of the grab ring to splay open.
2. The pliers according to claim 1 wherein the forked jaw members are U-shaped.
